(19) United States
(12) Patent Application Publication
(10) Pub. No.: US 2002/0198825 A1
(43) Pub. Date: Dec. 26, 2002

(54) Line of credit and loan system and method

(76) Inventor: Karl E. Jentoft, Washington, DC (US)

Correspondence Address: BAKER & MCKENZIE, 805 THIRD AVENUE, NEW YORK, NY, 10022, US

(21) Appl. No.: 09/887,292

(22) Filed: Jun. 22, 2001

(51) Int. Cl. G06F 17/60; G06K 5/00

(52) U.S. Cl. 705/39; 235/379; 235/380

(57) ABSTRACT

System and method for requesting a single payment for an account, including issuing a loan and a line of credit, determining loan payment information for the loan and determining line of credit payment information for the line of credit, storing loan payment information and line of credit payment information associated with the account, determining the single payment from the loan payment information and the line of credit payment information, and requesting the single payment due on the account.

### FIELD

The present application relates to a line of credit and loan system and method and, more particularly, to an account associated with a line of credit and a loan and a method for determining a single payment amount for payments due on the line of credit and the loan.

### BACKGROUND

A line of credit based on the equity in a home to secure a line of credit is a source of consumer credit. Lenders offer such secured home equity credit lines in a variety of ways. For example, lenders offer variable interest rates, low introductory rates and fixed interest rates. These home equity lines of credit require a consumer to use a home as collateral. Further, lines of credit are available to consumers that do not require a home or other asset as collateral and are referred to as unsecured lines of credit. For example, major credit cards, such as Mastercard® and Visa®, offer unsecured lines of credit. Whether secured or unsecured, a line of credit requires payments only upon an outstanding balance in an account. Contrary to a loan, there is no initial balance on a line of credit. The consumer is required to make a payment, for example, a minimum payment, each month based on a percentage of the balance.

Lenders also offer loans to consumers. Loans such as home equity loans are secured loans using a consumer's home as collateral. Generally, the loan is for a fixed period of time, whereby monthly payments are determined according to a fixed or variable interest rate. If the payments are determined according to a fixed interest rate or a variable interest rate fixed for a predetermined period of time, a payment schedule requires equal payments for the entire fixed period or the predetermined period of time. A consumer having both a home equity loan and a home equity line of credit must make separate payments to one or more lenders when payments are due. In addition, two liens are on the individual's home.

Therefore, there is a need for an account, such as a credit card account, associated with both a secured and/or unsecured line of credit and a secured loan. Accordingly, a single payment is due, for example, monthly, that includes a loan payment and a line of credit payment, if any.

### SUMMARY OF THE INVENTION

An aspect of the present application provides for a card, including a card body, and a machine readable portion on or within the card body for storing information associated with at least one line of credit and at least one loan.

Another aspect of the present application provides for a system for determining a payment of an account. The system includes a memory unit for storing payment information for a line of credit and a loan, the line of credit and the loan associated with the account, and a lender computer for determining the payment based on at least the payment information for the line of credit and the loan, wherein the payment requested to be paid includes both a payment for the line of credit and a payment for the loan.

A further aspect of the present application includes a credit card, includes a card body, and a magnetic strip on one side of the card body for storing information associated with at least one home equity line of credit and at least one home equity loan, wherein the at least one home equity line of credit is secured or unsecured and the at least one home equity loan is secured.

A still further aspect of the present application provides for a method for requesting a single payment for an account. The method includes issuing a loan, determining loan payment information for the loan according to a loan payment term and an interest rate, issuing a line of credit, determining line of credit payment information for the line of credit according to an outstanding balance and an interest rate, storing the loan payment information and the line of credit payment information associated with the account, determining the single payment from the loan payment information and the line of credit payment information, and requesting the single payment due on the account.

### BRIEF DESCRIPTION OF THE DRAWINGS

FIG. 1 illustrates an exemplary card according to the present application;

FIG. 2 illustrates an exemplary line of credit information and loan information associated with a card;

FIG. 3 illustrates an exemplary embodiment for establishing an account including a line of credit and a loan; and

FIG. 4 illustrates an exemplary system of the present application.

### DETAILED DESCRIPTION

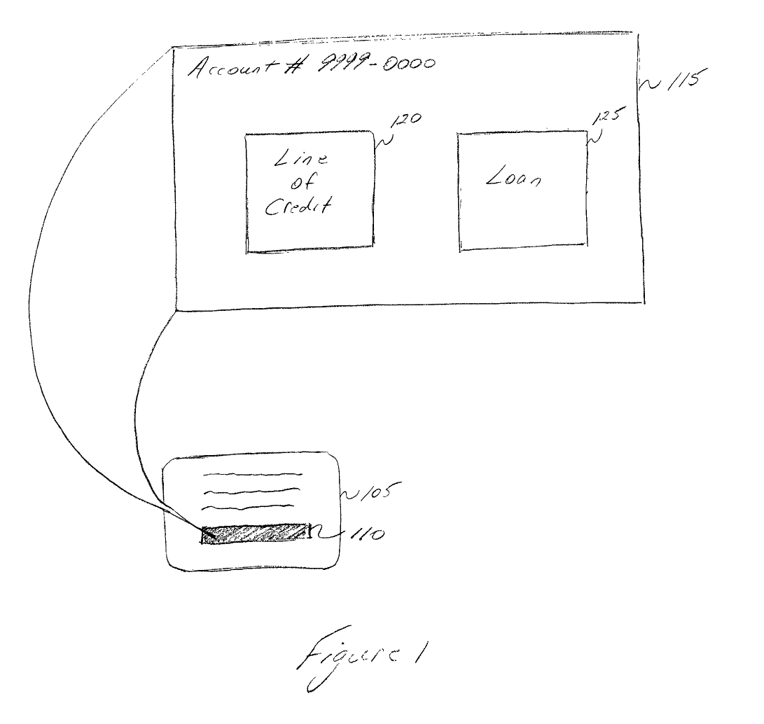

FIG. 1 illustrates an exemplary embodiment of card 105, such as a credit card, having two sides. As shown in FIG. 1, card 105 includes machine readable portion 110, for example, a magnetic strip, on one of the two sides. Other machine readable portions can be used as well, regardless of whether such portions are read with contact or without contact. Even though the exemplary embodiments refer to card 105 as a credit card, the present application is not limited to a credit card. Rather, card 105 can be a debit card, a smart card or the like. In addition, the present application is not limited to a physical card and the use of the same, but rather a predetermined account number or other number can be used by an individual, for example, by a consumer, as opposed to presenting a physical card.

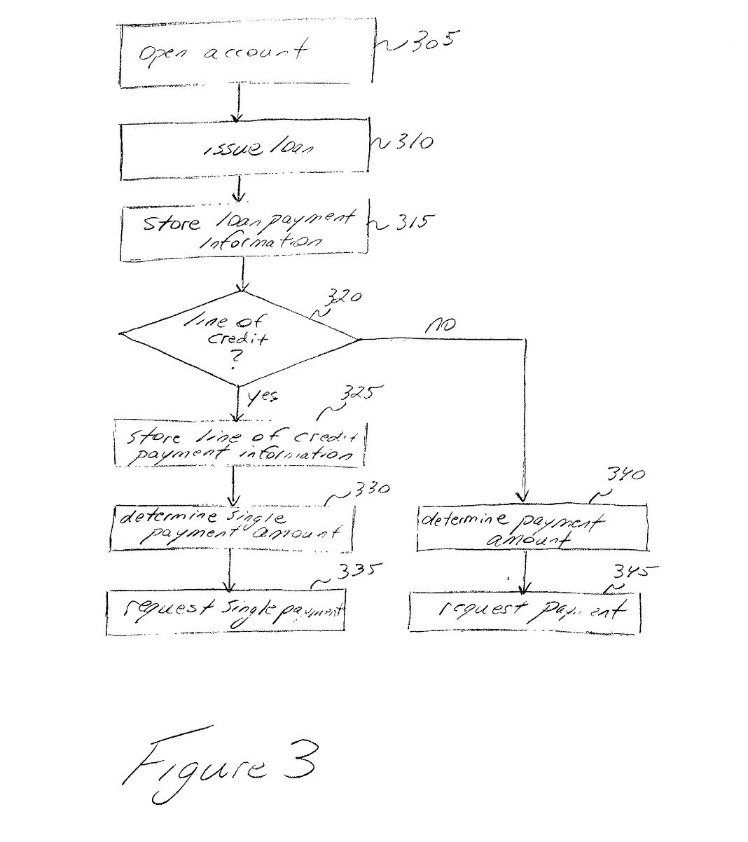

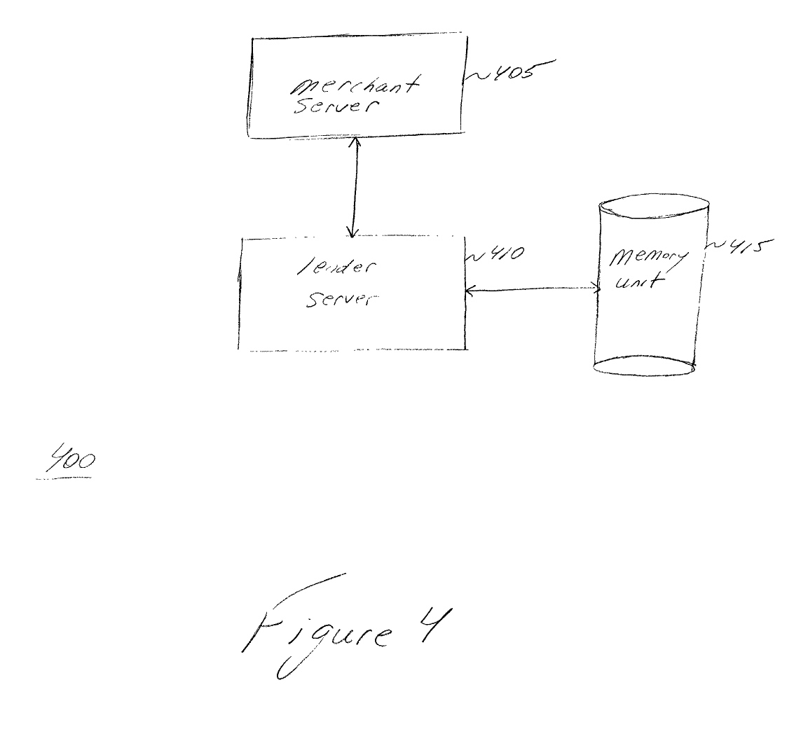

FIG. 4 illustrates an exemplary system 400 of the present application. System 400 includes merchant computer 405, for example, a merchant server, lender computer 410, for example, a lender server, and memory unit 415, for example, a database. Upon a consumer using card 105 and/or presenting a predetermined account number to, for example, a merchant, merchant server 405 transmits credit or debit information to lender server 410. Lender server 410 generates a payment amount according to information stored in database 415, discussed below with reference to FIG. 3, and requests payment from the consumer. Merchant server 405, lender server 410 and database 415 are merely exemplary. Additional servers and databases can be utilized in or with system 400.

Machine readable portion 110, shown in FIG. 1, can be read, for example, by a point-of-service credit card machine coupled to merchant server 405 when a consumer makes a purchase or when a consumer withdraws money from an automatic teller machine. Machine readable portion 110 includes information for providing access to one or more accounts of the owner of the card. The process of accessing accounts by reading information stored on a machine readable portion of a card by contact or without contact is well known in the art.

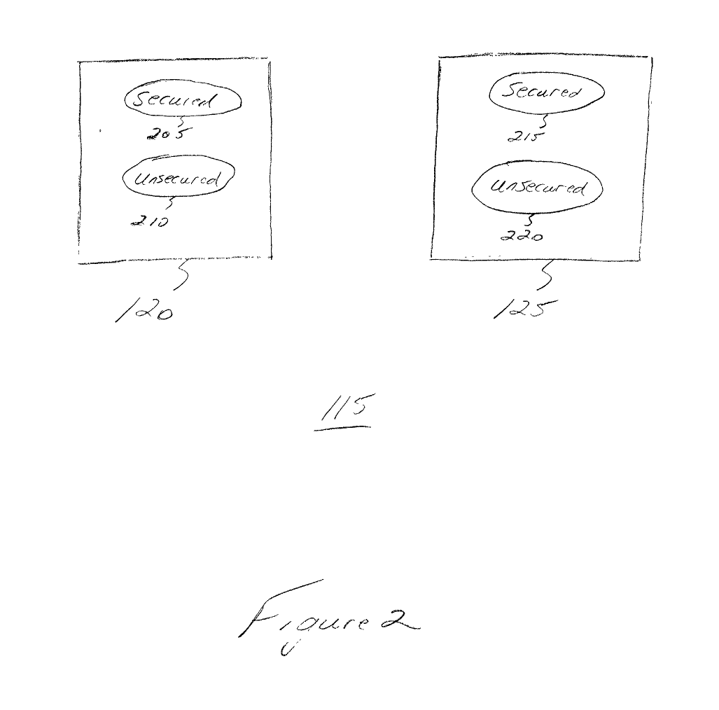

In an exemplary embodiment, information stored on machine readable portion 110 is associated with card owner account 115 having a predetermined account number. More particularly, the information stored on machine readable portion 110 is associated with line of credit information 120 and loan information 125 associated with card owner account 115. Line of credit information 120 and loan information 125 are described below with reference to FIGS. 2 and 3. The card owner can use the card 105, for example, as a conventional credit card, thereby increasing an outstanding balance associated with line of credit information 120.

FIG. 2 depicts line of credit information 120 and loan information 125 associated with card owner account 115 stored in database 415. As can be seen in FIG. 2, line of credit information 120 can be-associated with one or more secured lines of credit 205 and/or one or more unsecured lines of credit 210. Further, loan information 125 can be associated with one or more secured loans 215 and/or one or more unsecured loans 220. In an exemplary embodiment, a secured line of credit is any loan in which the issuer of the loan has a security interest in the collateral given as an inducement to the issuer to grant the loan. The manner in which the issuer of the loan must perfect the security interest in the collateral depends on the nature of the collateral. For example, the security interest in traditional secured cards is perfected, then the card issuer possesses the cardholder's deposit. In contrast, the security interest in a home equity line of credit card is perfected by recording a valid lien against the real property securing the loan. In an exemplary embodiment, line of credit information 120 includes line of credit payment information and loan information 125 includes loan payment information.

FIG. 3 illustrates an exemplary method for generating a single credit card payment amount including a line of credit payment amount and a loan payment amount. In an exemplary embodiment, line of credit information 120 is associated with a home equity line of credit and loan information 125 is associated with a home equity loan. In an alternative embodiment, line of credit information 120 and loan information 125 are not associated with home equity, but rather can be associated with other types of collateral. A lender first opens account 115 having a predetermined account number for one or more account owners, in 305. Once account 115 is opened by the lender, a home equity loan can be requested by an account owner and issued to the account owner via lender server 410, in 310. Specifically, the lender issues a home equity loan to the owner of the account based on, for example, credit history, ability to make payments and/or value of collateral. The home equity loan is a loan secured by a home of one of the owners of the account. There are various structures and payment schedules for home equity loans well known in the art. For example, the home equity loan can be a fixed term loan with a fixed interest rate having a fixed payment schedule or a fixed term loan with a variable interest rate. The issued home equity loan is associated with account 115. Accordingly, loan information 125 is stored in database 415 in association with account 115, in 315. Loan information 125 includes loan payment information, for example, amount of money to be paid monthly by the account owner.

The lender thereafter can receive a request by the account owner for a line of credit, for example, a home equity line of credit. In an exemplary embodiment, the home equity line of credit functions as a conventional line of credit, that is an account owner receives a line of credit for a particular amount of money which the owner can charge against and/or can receive cash advances. Any outstanding balance is determined according to the amount of past purchases plus a predetermined fixed or variable interest rate, balance transfers plus a predetermined fixed or variable interest rate and/or cash advances plus a predetermined fixed or variable interest rate. The lender thereafter examines, for example, credit history, ability to make payments and/or value of collateral in order to determine whether to issue a line of credit and for what amount of money, in 320.

In an exemplary embodiment, the home equity line of credit is a line of credit secured by a home. The line of credit can be secured by the same home that secures the home equity loan issued to the account owner. The home equity line of credit can be secured by other collateral as well or the line of credit can be secured by a predetermined amount of money submitted by the account owner to the lender which can operate as a spending cap. In an alternative embodiment, the line of credit can be unsecured or the line of credit can have a secured portion and an unsecured portion.

After the line of credit is issued by the lender, in 320, the issued line of credit is associated with account 115. Accordingly, line of credit information 120 such as line of credit payment information is stored in database 415 in association with account 115, in 325. Line of credit payment information 120 includes, for example, monthly payment due which includes at least a portion of an outstanding balance plus interest. The interest can be based on a fixed interest rate or a variable interest rate.

In an exemplary embodiment, the lender generates account invoices monthly. The account invoices are sent to account owners and include information regarding a request for payment. If account 115 has an outstanding balance for a line of credit and a loan, lender server 415 generates a respective account invoice includes a single payment amount, in 330. The single payment amount can be generated by adding a payment due amount for the home equity loan and a payment due amount for the home equity line of credit stored in database 415. For example, a payment due on a home equity loan pursuant to a fixed payment schedule plus a payment due on a home equity line of credit pursuant to an outstanding balance and interest accrued is calculated by lender server 410. The single payment amount is sent to the owner of the respective account, in 335.

If the account owner does not have a line of credit with the lender or there is no current outstanding balance or no payment is due on the line of credit, lender server 410 generates a payment amount for the respective home equity loan, in 340. The payment amount is sent to the owner of the respective account, in 345.

It should be noted that the ordering of FIG. 3 is merely exemplary. For example, a line of credit can be issued first and then a loan can be issued to an account owner.

The embodiments described above are illustrative examples of the present invention and it should not be construed that the present invention is limited to these particular embodiments. Various changes and modifications may be effected by one skilled in the art without departing from the spirit or scope of the invention as defined in the appended claims.

What is claimed is:

1. A card, comprising:
a card body; and
a machine readable portion on or within the card body for storing information associated with at least one line of credit and at least one loan.

2. The card as set forth in claim 1, wherein the machine readable portion is a magnetic strip.

3. The card as set forth in claim 1, wherein the at least one line of credit is a home equity line of credit.

4. The card as set forth in claim 1, wherein the at least one loan is a home equity loan.

5. The card as set forth in claim 1, wherein one of the at least one line of credit is secured and another of the at least one line of credit is unsecured.

6. The card as set forth in claim 1, wherein the at least one loan is secured.

7. The card as set forth in claim 1, wherein the at least one line of credit includes an outstanding balance subject to a variable interest rate or a fixed interest rate.

8. The card as set forth in claim 1, wherein the at least one loan is a fixed term loan having a variable interest rate or a fixed interest rate.

9. A system for determining a payment of an account, comprising:
a memory unit for storing payment information for a line of credit and a loan, the line of credit and the loan associated with the account; and
a lender computer for determining the payment based on at least the payment information for the line of credit and the loan, wherein
the payment requested to be paid includes both a payment for the line of credit and a payment for the loan.

10. The system as set forth in claim 9, wherein
the line of credit is secured or unsecured.

11. The system as set forth in claim 9, wherein
the line of credit is a home equity line of credit.

12. The system as set forth in claim 9, wherein
the loan is secured.

13. The system as set forth in claim 12, wherein
the loan is a home equity loan.

14. The system as set forth in claim 9, wherein
the account is a credit card account, a debit card account or a smart card account.

15. The method as set forth in claim 9, wherein
the payment is determined monthly.

16. A credit card, comprising:
a card body; and
a magnetic strip on one side of the card body for storing information associated with at least one home equity line of credit and at least one home equity loan, wherein
the at least one home equity line of credit is secured or unsecured and
the at least one home equity loan is secured.

17. A method for requesting a single payment for an account, comprising:
issuing a loan;
determining loan payment information for the loan according to a loan payment term and an interest rate;
issuing a line of credit;
determining line of credit payment information for the line of credit according to an outstanding balance and an interest rate;
storing the loan payment information and the line of credit payment information associated with the account;
determining the single payment from the loan payment information and the line of credit payment information; and
requesting the single payment due on the account.

18. The method as set forth in claim 17, wherein
the line of credit is secured or unsecured.

19. The method as set forth in claim 17, wherein
the line of credit is a home equity line of credit.

20. The method as set forth in claim 17, wherein
the loan is secured.

21. The method as set forth in claim 20, wherein
the loan is a home equity loan.

22. The method as set forth in claim 17, wherein
the interest rate associated with the line of credit is a fixed interest rate.

23. The method as set forth in claim 17, wherein
the interest rate associated with the line of credit is a variable interest rate.

24. The method as set forth in claim 17, wherein
the interest rate for the loan is a fixed interest rate.

25. The method as set forth in claim 17, wherein
the interest rate for the loan is a variable interest rate.

26. The method as set forth in claim 17, wherein
the account is a credit card account, a debit card account or a smart card account.

27. The method as set forth in claim 17, wherein
the single payment is determined monthly.
